(19) United States
(12) Patent Application Publication
(10) Pub. No.: US 2020/0284084 A1
(43) Pub. Date: Sep. 10, 2020

(54) METHOD FOR OPERATING A DRIVE SYSTEM FOR A BODY HATCH OF A MOTOR VEHICLE

(71) Applicant: Brose Fahrzeugteile SE & Co. Kommanditesellschaft, Bamberg, Bamberg (DE)

(72) Inventors: Robin RUDOLPH, Schönbrunn im Steigerwald (DE); Rene KAMPFMANN, Gunzenbach (DE)

(73) Assignee: Brose Fahrzeugteile SE & Co. Kommanditgesellschaft, Bamberg, Bamberg (DE)

(21) Appl. No.: 16/765,310

(22) PCT Filed: Nov. 19, 2018
(86) PCT No.: PCT/EP2018/081753

§ 371 Date: May 19, 2020

(30) Foreign Application Priority Data
Nov. 20, 2017 (DE) 10 2017 127 292.5

(51) Int. Cl. E05F 15/70; B62D 25/12; B62D 25/10; G07C 5/08; E05F 15/622; E05B 83/24

(52) U.S. Cl. CPC E05F 15/70; B62D 25/12; B62D 25/105; B60J 5/04; E05F 15/622; E05B 83/24; G07C 5/0808

(57) ABSTRACT

A method for operating a drive system for a body hatch, in particular a front hood of a motor vehicle, wherein the drive system has a motorized drive arrangement and a control device for actuating the drive arrangement, wherein the body hatch, in an opening process, is adjusted from a closed position in an opening direction. A faulty opening process of the body hatch is detected by means of the control device in a detection routine and that, upon detection of a faulty opening process, the drive arrangement is actuated by means of the control device in the closing direction.

### CROSS-REFERENCE TO RELATED APPLICATIONS

This application is the U.S. National Phase of PCT Application No. PCT/EP2018/081753 filed on Nov. 19, 2018, which claims priority to German Patent Application No. DE 10 2017 127 292.5, filed on Nov. 20, 2017, the disclosures of which are hereby incorporated in their entirety by reference herein.

### TECHNICAL FIELD

The present disclosure relates to a method of operating a drive system for a body hatch of a motor vehicle.

### BACKGROUND

Today, body hatches which can be activated in a motorized manner are widely used, especially for the rear hatch of station wagons. The drive system may include a drive arrangement and a control device for actuating the drive arrangement. The rear hatch may be opened by means of the drive arrangement in a motorized opening process and closed by means of the drive arrangement in a motorized closing process.

### SUMMARY

The present disclosure may provide increased operational reliability of a drive system by simple constructive means.

In the event of a faulty opening process, the drive arrangement or method of operating the same as provided in the present disclosure may be used to counteract the continuation of the undesired opening process.

As an example, it is proposed that a faulty opening process of the body hatch is detected by means of the control device in a detection routine and that, upon detection of a faulty opening process, the drive arrangement is actuated by means of the control device in the closing direction. This means that the drive arrangement is actuated by means of the control device in such a way that a driving force or a driving torque acts on the body hatch in its closing direction.

With the proposed solution, the operational reliability of the said drive system may be increased with regard to an undesired swinging open of the body hatch in such a way that a configuration of the body hatch as a front hood is now safe. The configuration of the body hatch as a front hood constantly requires particularly good reliability against a faulty opening process, since a resultant, undesired swinging open of the body hatch is always associated with obstructing the vision of the vehicle driver.

A faulty opening process while driving may result in the headwind further promoting the swinging open of the front hood, for example, when the body hatch effectively acts as a sail in the headwind. In this regard, a measure which counteracts the opening process is may be useful if a front hood opens in the driving direction of the motor vehicle. This is because, with such a front hood, the hood opening produced in the course of the opening process faces in the driving direction.

As proposed above, using the drive arrangement, which is provided in any case, for these measures results in a cost-effective and, at the same time, compact overall arrangement.

The proposed solution may be used, for example, for motor vehicles having an internal combustion engine, in which the internal combustion engine is located under the front hood. As an example, however, the proposed solution may be used in motor vehicles having an electric traction drive. The reason for this is that, with appropriate accommodation of the electric motor associated with the traction drive, the front hood there may be a closed a trunk which may be conveniently opened and closed in a motorized manner by means of the drive arrangement.

In one or more embodiments, the front hood, in the installed state, opens in the driving direction of the motor vehicle in the course of the opening process. As addressed above, this means that the hood opening produced in the course of the opening process faces in the driving direction.

A faulty opening process may be defined in different ways in the control device. As an example, an opening process is always regarded as a faulty opening process if the opening process is detected when driving. This is also appropriate since an opening of the body hatch, such as a front hood, is always undesired while driving.

As another example, any opening process which is detected without an associated operating event having been detected beforehand is also regarded as a faulty opening process. In other words, only those opening processes which stem from a predetermined operating event detected by a control device are classed as correct.

Various advantageous variants are likewise conceivable for detecting an above opening process. For example, it may be provided that a sensor for detecting an adjustment of the body hatch may be provided for this. As an example, a measure of the progress of the opening process may be detected thereby. As an example, a lock status sensor may be provided to detect an opening process by retrieving data from the lock status sensor of a motor vehicle lock associated with the body hatch.

In one or more embodiments, it may be proposed to actuate the drive arrangement with a different drive power depending on the detected vehicle speed. On the one hand, this ensures good operational reliability at different vehicle speeds, whilst, especially at low vehicle speeds, damage to the drive arrangement and the components coupled thereto, which is caused by the drive arrangement being actuated with excessive drive power, is prevented.

In one or more embodiments, the control device may be configured such that, upon detection of a faulty opening process, the drive arrangement is actuated in the closing direction.

The above-mentioned embodiments may be applied to a motor vehicle or a hatch arrangement for the motor vehicle.

In one or more embodiments, a drive arrangement configuration, kinematics and arrangement of the body hatch may be provided so that the body hatch, in the event of a faulty opening process, may also be arrested or adjusted in the closing direction at relatively high vehicle speeds.

### BRIEF DESCRIPTION OF THE DRAWINGS

The invention is explained in more detail below with the aid of a drawing which merely represents one exemplary embodiment. The drawing shows:

FIG. 1 the front region of a proposed motor vehicle, which is designed for carrying out a proposed method.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A known method of operating a drive system for a body hatch of a motor vehicle is provided in DE 10 2010 054 975 B3. The drive system has a drive arrangement and a control device for actuating the drive arrangement, wherein the hatch leaf can be opened by means of the drive arrangement in a motorized opening process and closed by means of the drive arrangement in a motorized closing process. Measures against a fault-induced and therefore undesired opening process for the body hatch configured as a hatch leaf, which is referred to in the present case as “faulty opening process”, have not been addressed in the known method, which means that operational reliability is limited in this respect. Such a faulty opening process can stem from a mechanical or control-related malfunction.

The proposed method is based on the operation of a drive system 1 for a body hatch 2, such as a front hood 3, of a motor vehicle 4. In view of the high operational reliability which can be achieved by the proposed solution, the proposed method may be suitable for a front hood 3. However, the proposed method may also be applied to a rear hatch, a rear lid, a side door, a rear door or the like.

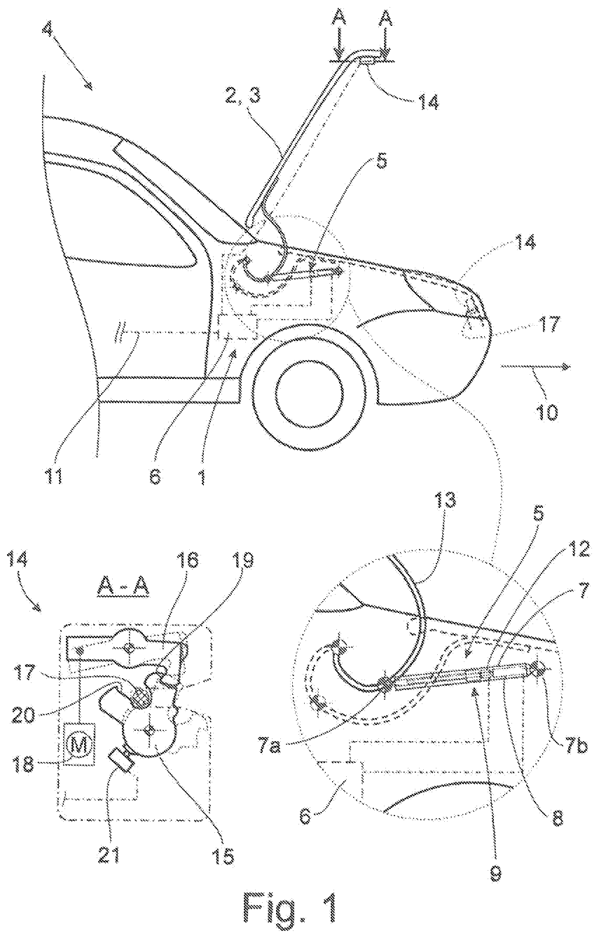

The drive system 1 has a motorized drive arrangement 5 and a control device 6 for actuating the drive arrangement 5. Quite generally, the body hatch 2 can be adjusted in an opening process from a closed position in the direction of an open position, i.e. in the opening direction, as revealed in the illustration according to FIG. 1. The opening process can be driven by the drive arrangement 5. However, it is also conceivable that the opening process is driven by external forces acting on the body hatch 2. Such forces can stem from manual activation, from a headwind while driving or the like.

A faulty opening process, i.e. an opening process which is not planned to take place, can stem, for example, from breakage of a mechanical component which has yet to be explained. However, a faulty opening process can also stem from a control error which results in the body hatch 2 being released in error.

As an example, a faulty opening process of the body hatch 2 is detected by means of the control device 6 in a detection routine and that, upon detection of a faulty opening process, the drive arrangement 5 is actuated by means of the control device 6 in the closing direction of the body hatch 2.

The drive arrangement 5 may be equipped with at least one spindle drive 7, which has a drive motor 8 and a spindle/spindle nut gear 9 connected downstream of the drive motor 8. Other types of drive concept for the drive arrangement 5 are conceivable.

In one or more embodiments, the drive arrangement 5 may be configured such that it is not self-locking. This means that a movement can be introduced into the spindle drive 7 via the connections 7a, 7b of the spindle drive 7 and results in a reversal of the spindle/spindle nut gear 9 and possibly the drive motor 8. It is therefore particularly easily possible to adjust the body hatch 2 not only in a motorized manner but also manually.

The drive arrangement 5 may be configured for self-locking. This means that the introduction of a movement into the spindle drive 7 via the connections 7a, 7b is blocked by the drive train between the connections 7a, 7b. This is advantageous insofar as the body hatch 2 is arrested automatically in each hatch position.

It has already been noted that the proposed method may be used on a front hood 3 of a motor vehicle 4. This is this case, if the front hood 3, in the installed state, opens in the driving direction 10 of the motor vehicle 4 in the course of the opening process. Such a design of a front hood 3 is illustrated in FIG. 1.

A reproducible adjustment of the body hatch 2 is realized in that a motorized opening process from a closed position in the opening direction of the body hatch 2 and a motorized closing process from an open position in the closing direction of the body hatch 2 is generated by means of the drive arrangement 5. It may also be provided that only one of these two processes is generated by means of the drive arrangement 5. For example, it is conceivable that only a motorized closing process is generated by means of the drive arrangement 5, whilst it is provided for the opening process to be driven by a spring.

In the control device 6, the definition of a faulty opening process can stem from detecting that the motor vehicle 4 is being driven. In detail, it is proposed in this regard that the driving of the motor vehicle 4, such as the driving speed of the motor vehicle 4, is detected by means of the control device 6. In the control device 6, the faulty opening process is then defined in that an opening process is detected while driving, such that at a vehicle speed above a predetermined limit speed. The limit speed can also be a driving speed of more than 10 km/h, or more than 30 km/h or more than 50 km/h.

The detection of the driving speed of the motor vehicle 4 may stem from the communication of the control device 6 with a superordinate control device which provides vehicle data, such as the driving speed, via a vehicle bus 11.

To enable the motorized opening and closing processes to be initiated in an operator-controlled manner, it may be the case that the occurrence of a predetermined operating event is detected by means of the control device 6 in an operating-event monitoring routine. Such an operating event can be, for example, the activation of a remote-control key or the like. It is also conceivable that a superordinate control device provides gesture recognition so that an opening and closing process can be initiated by an operator gesture, for example a foot movement of the operator. The occurrence of an operating event is in turn may be provided by a superordinate control device via the vehicle bus 11.

If an operating-event monitoring routine, addressed above, is provided, the definition of a faulty opening process in the control device 6 may be determined such that an opening process is detected without an associated operating event having been detected beforehand.

In the illustrated and, in this regard, the motor vehicle 4, different variants can be advantageous for detecting an opening process.

A variant for detecting the opening process stems from a position sensor 12, coupled to the control device 6, being associated with the drive arrangement 5, here the spindle drive 7, which position sensor detects an adjustment of the body hatch 2 in the opening direction and therefore an opening process. As a result of the spindle drive 7 here being coupled in terms of movement to the body hatch 2 via a swing arm 13, the sensor signals of the position sensor 12 impart information relating to the position of the body hatch 2. Alternatively, the position sensor 12 can also be associated with the body hatch 2, such as with a swing arm 13 addressed above, so that the position of the body hatch 2 can be determined directly.

The above position sensor 12 associated with the drive arrangement 5 can comprise, for example, a Hall sensor element or a plurality of Hall sensor elements, which determine(s) a rotational speed of a drive component, for example the motor shaft of a drive motor 8 of the drive arrangement 5. In this case, it is assumed that an adjustment of the body hatch 2 generates a corresponding adjustment of the drive component. Alternatively, it can also be provided that an adjustment of the motor shaft of the drive motor 8 of the drive arrangement 5, which stems from an adjustment of the body hatch, is identified on the basis of the measurement of an electric generator voltage induced in the associated motor windings. Depending on the wiring of the drive motor 8, the measurement of an electric generator current can also be used here to identify an adjustment of the body hatch 2.

A further variant for detecting the opening process stems from the presence of a motor vehicle lock 14. The illustration according to FIG. 1 reveals that a motor vehicle lock 14 is associated with the body hatch 2, which motor vehicle lock is in a main closed position when the body hatch 2 is located in the closed position. The motor vehicle lock 14 has the conventional locking elements: lock catch 15 and pawl 16. The lock catch 15 is in the main closed position illustrated in FIG. 1, in which it can be brought into arresting engagement with a locking part 17. The main closed position of the lock catch 15 is illustrated by a continuous line in FIG. 1.

The lock catch 15 can furthermore be brought into an open position, illustrated by a dashed line, in which it releases the locking part 17.

Finally, the lock catch 15 can be brought into a pre-closed position, which is located between the main closed position and the open position and in which the lock catch 15 is likewise in arresting engagement with the locking part 17.

In the main closed position and in the pre-closed position, the lock catch 15 is blocked by the pawl 16 so as to prevent the lock catch 15 from pivoting into its open position. The pawl 16 is pre-tensioned in its latching position shown in FIG. 1 by a spring and can be lifted out by means of a pawl drive 18 so that the lock catch 15 is released and the motor vehicle lock as a whole is opened.

The above pre-closed position is, to some extent, a safety position in case the pawl 16 should slip out of the main detent 19 of the lock catch 15, which is associated with the main closed position. In such a case, the pawl 16 comes into blocking engagement with the pre-detent 20 of the lock catch 15, which is associated with the pre-closed position.

In one or more embodiments, it is now the case that a lock status sensor 21 coupled to the control device 6 is associated with the motor vehicle lock 14, which lock status sensor detects a deviation from the main closed position and therefore an opening process. The lock status sensor 21 is configured as a position sensor here for detecting the position of the lock catch 15, as indicated in FIG. 1. Quite generally, the motor vehicle lock 14 here is designed to detect whether the body hatch 2 is, or is not, completely closed. In the second case, an opening process has been initiated, which possibly relates to a faulty opening process.

Other sensor systems that may be present in any case can also be used for detecting an opening process. Such a sensor system can be provided to provide sensor measurement values for the operating-event monitoring routine. The sensor system can have different configurations. For example, the sensor system can be equipped with at least one proximity sensor, which serves, for example, to detect a looming collision of the motor vehicle 4 with an obstacle or to detect an operator gesture. With an appropriate configuration, an opening process results in the generation of corresponding sensor measurement values via the sensor system, so that an opening process can be readily detected by means of the sensor system. Capacitive or inductive proximity sensors may be used here, which can be arranged on the body hatch 2 or on the body of the motor vehicle 4.

Sensor systems which have at least one optical sensor can furthermore be used for detecting an opening process. Such an optical sensor can be a camera sensor, which is arranged, for example, in an upper region of the windshield and whereof the detecting direction faces in the driving direction. Alternatively to this, the optical sensor can be a light barrier sensor, which is triggered, such as, when the body hatch 2, during the opening process, enters the detecting section of the light barrier sensor or exits the detecting section of the light barrier sensor.

The control device 6 can react to the detection of a faulty opening process in different ways. For example, it can be provided that, upon detection of a faulty opening process, the drive arrangement 5 is actuated by means of the control device 6 in the closing direction in such a way that the body hatch 2 is arrested. It can be alternatively or additionally provided that, upon detection of a faulty opening process, the drive arrangement 5 is actuated by means of the control device 6 in the closing direction, in such a way that an adjustment of the body hatch 2 takes place in the closing direction. It can furthermore be alternatively or additionally provided that, upon detection of a faulty opening process, the drive arrangement 5 is actuated by means of the control device 6 in the closing direction in such a way that an adjustment of the body hatch 2 takes place in its closing direction. It may be provided that, upon detection of a faulty opening process, the drive arrangement 5 is actuated by means of the control device 6 in the closing direction in such a way that the motor vehicle lock 14 is transferred to a closed position, such as to the pre-closed position addressed above. Provided the drive arrangement 5 is designed accordingly, it can also be provided that the drive arrangement 5 is actuated in the closing direction in such a way that the motor vehicle lock 14 is transferred to the main closed position.

In one or more embodiments, explained above, for the reaction of the control device 6 to detecting a faulty opening process, it is ensured that the body hatch 2 cannot be adjusted further in the opening direction of the body hatch 2 since the proposed actuation of the drive arrangement 5 counteracts such an adjustment in the opening direction.

A relatively efficient prevention of the undesired swinging open of the motor vehicle hatch 2 is may be realized in that, upon detection of a faulty opening process, the drive arrangement 5 is actuated by means of the control device 6 in the closing direction with varying drive power depending on the detected vehicle speed. In this case, it is provided, such as, that the drive power increases with the increasing driving speed. It may be provided that the drive power increases proportionally, such as linearly, with the driving speed. However, it can also alternatively be provided that the drive power increases discontinuously, correspondent to reaching predetermined driving speed stages.

To give the vehicle driver the earliest possible option of reducing the driving speed of the motor vehicle upon the occurrence of a faulty opening process, it may be provided that, upon detection of a faulty opening process, a warning alert is transmitted to the vehicle driver by means of the control device 6 via a human-machine interface. Such a warning alert can be provided optically or acoustically.

According to a further teaching, which is attributed independent importance, a drive system 1 for a body hatch 2, such as a front hood 3, of a motor vehicle 4 for carrying out a proposed method is claimed. In a likewise independent teaching, a hatch arrangement having a body hatch 2, such as a front hood 3, of a motor vehicle 4 and an above drive system 1 associated with the body hatch 2 is furthermore claimed as such. Finally, a motor vehicle 4 having such a hatch arrangement is claimed as such. For an explanation of all further independent teachings, it is possible to refer to all embodiments relating to the proposed method.

With regard to the motor vehicle 4, it may be noted that the drive arrangement 5 which is associated with the body hatch 2 may be designed with greater power for the proposed method than is inherently required for the motorized adjustment of the body hatch 2 in normal operation. In any case, it may be provided that the drive arrangement 5 is designed to arrest the front hood 3 which is open by 10% at a vehicle speed of 10 km/h, or 30 km/h, or 50 km/h, and/or to adjust it in the closing direction, such as into the closed position of the front hood 3. In the present case, the wording “open by 10%” means that the front hood has opened from its closed position through 10% of the total adjustment path between the closed position and the open position of the front hood 3. Such a design of the drive arrangement 5 may enable considerable operational reliability, even in the event that the vehicle driver reacts relatively late to the occurrence of a faulty opening process.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### PARTS LIST

1 drive system
2 motor vehicle hatch
3 front hood
4 motor vehicle
5 drive arrangement
6 control device
7 spindle drive
8 drive motor
9 spindle/spindle nut gear
10 driving direction
11 vehicle bus
12 position sensor
13 swing arm
14 motor vehicle lock
15 conventional locking elements: lock catch
16 pawl
17 locking part
18 pawl drive
19 main detent
20 pre-detent
21 lock status sensor
7a connections
7b connections

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method for operating a drive system for a body hatch of a motor vehicle, wherein the drive system includes a motorized drive arrangement and a control device configured to actuate the drive arrangement and the body hatch is adjustable from a closed position in an opening direction in an opening process, the method comprising:
by the control device,
detecting
a faulty opening process of the body hatch curing a detection routine; and
actuating the motorized drive arrangement to move the body hatch in a closing direction, in response to the detecting step.

2. The method of claim 1, wherein the body hatch is a front hood and during the detecting step, the front hood is installed such that the front hood opens in a driving direction of the motor vehicle.

3. The method of claim 1, further comprising:
operating the motorized drive arrangement to open the body hatch from the closed position to the open position before or during the detecting step.

4. The method of claim 1, further comprising:
receiving a driving speed of the motor vehicle, wherein the detecting step includes receiving the driving speed that is above a predetermined limit speed.

5. The method of claim 1, further comprising:
executing an operating-event monitoring routine;
detecting an occurrence of a predetermined operating event; and
actuating the motorized drive arrangement control device in response to detecting the occurrence of the predetermined operating event.

6. The method of claim 5, wherein the detecting the faulty opening process of the body hatch includes detecting an opening process without detecting an associated operating event beforehand.

7. The method of claim 1, wherein the detecting step includes detecting an adjustment of the body hatch or the motorized drive arrangement by a position sensor coupled to the control device.

8. The method of claim 1, wherein the detecting step includes detecting, by a lock status sensor coupled to the control device, a motor vehicle lock, coupled to the body hatch, deviating from a main closed position.

9. The method of claim 1, further comprising:
actuating the motorized drive arrangement in a second closing direction to arrest the body hatch.

10. The method of claim 8, wherein actuating the driving arrangement in the second closing direction includes transferring the motor vehicle lock to a closed position or a pre-closed position.

11. The method of claim 1, wherein the actuating step includes varying drive power based on a detected vehicle speed.

12. A drive system configured to adjust a body hatch of a motor vehicle, the drive system comprising:
a drive arrangement including a motor operable to adjust the body hatch; and
a control device configured to, responsive to detecting an inadvertent movement of the body hatch in an opening direction, actuate the drive arrangement to move the body hatch in a closing direction, opposite the opening direction.

13. (canceled)

14. A motor vehicle comprising:
a hatch arrangement including a body hatch;
a drive system configured to move the body hatch between an open position and a closed position; and
a control device configured to, responsive to detecting an inadvertent movement of the body hatch in an opening direction, actuate the drive arrangement to move the body hatch in a closing direction, opposite the opening direction.

15. The motor vehicle of claim 14, wherein the control device is configured to actuate the drive arrangement to arrest the front hood, in response to the body hatch being open by 10% and a vehicle speed ranging between 10 km/h and 50 km/h.

16. The motor vehicle of claim 15, wherein the body hatch is a hood and the drive arrangement includes a spindle device and awing arm connected to the hood.

17. The motor vehicle of claim 15, wherein the body hatch is a hood and the drive arrangement includes a spindle drive and a swing arm connected to the hood.

17. The motor vehicle of claim 16, wherein the hatch arrangement includes a vehicle lock, configured to lock the hood to the body when the vehicle lock is in a main closed position and a pre-closed position and a lock status sensor configured to detect a position of the vehicle lock, wherein the control device is further configured to be responsive to the motor vehicle lock being in an open position.

18. The motor vehicle of claim 17, wherein the control device is further configured to actuate the spindle drive to move the hood such that the vehicle lock moves from the open position to the pre-closed position.

19. The motor vehicle of claim 18, further comprising a position sensor configured to detect movement of the spindle drive, the swing arm, and/or the hood and wherein the control device is further responsive to receiving signals from the position sensor indicative of the inadvertent movement.

20. The motor vehicle of claim 19, further comprising a collision sensor configured to detect a predicted collision, wherein the controller is further configured to, responsive to the collision sensor detecting the predicted collision, actuating the spindle drive to fix the position of the spindle drive and the hood.
